(19) United States
(12) Patent Application Publication
(10) Pub. No.: US 2017/0193776 A1
(43) Pub. Date: Jul. 6, 2017

(54) LEAVE BEHIND LABEL

(71) Applicant: CHECKPOINT SYSTEMS, INC., Thorofare, NJ (US)

(72) Inventors: George West, Aston, PA (US); Takeshi Matsumoto, Kanagawa (JP); Yuji Suzuki, Kanagawa (JP)

(21) Appl. No.: 14/985,973

(22) Filed: Dec. 31, 2015

(51) Int. Cl. G08B 13/24

(52) U.S. Cl. CPC G08B 13/2434; G08B 13/244

(57) ABSTRACT

In one embodiment, a security includes a planar EAS component having opposing first and second surfaces; and an adhesive layer adhered to the second surface of the planar EAS component and configured to adhere the planar EAS component to an object; wherein the first surface of the planar EAS component comprises a perforation line defining a closed interior portion of the planar EAS component and an exterior portion of the planar EAS component; and wherein the adhesive layer has a strength such that, when the adhesive layer is adhered to the object and the exterior portion is peeled away from the object, the planar EAS component tears along the perforation line and the interior portion remains adhered to the object.

### BACKGROUND

Electronic article surveillance (EAS) labels are well known. Such labels can be adhered to products or other objects and cause an alarm when the object is taken to an exit of a store. But thieves can prevent such an alarm by removing the EAS label. There is need of an affordable EAS label that, when attempted to be removed, tears to leave behind a portion of the label, thereby discouraging theft or resale.

### BRIEF SUMMARY

The present disclosure is directed to a security label and a method of manufacturing same. In one aspect, a security label includes a planar EAS component having opposing first and second surfaces; and an adhesive layer adhered to the second surface of the planar EAS component and configured to adhere the planar EAS component to an object; wherein the first surface of the planar EAS component comprises a perforation line defining a closed interior portion of the planar EAS component and an exterior portion of the planar EAS component; and wherein the adhesive layer has a strength such that, when the adhesive layer is adhered to the object and the exterior portion is peeled away from the object, the planar EAS component tears along the perforation line and the interior portion remains adhered to the object.

In another aspect, a method of manufacturing a security label includes providing a planar EAS component having opposing first and second surfaces; applying an adhesive layer to the second surface, the adhesive layer configured to adhere the planar EAS component to an object; and cutting a perforation line in the planar EAS component, the perforation fine defining a closed interior portion of the planar EAS component and an exterior portion of the planar EAS component; wherein the adhesive layer has a strength such dun when the adhesive layer is adhered to the object and the exterior portion is peeled away from the object, the planar EAS component tears along the perforation line and the interior portion remains adhered to the object.

In yet another aspect, a security label includes a planar EAS component having opposing first and second surfaces and a capacitor plate; and a single adhesive layer adhered to the second surface of the planar EAS component and configured to adhere the planar EAS component to an object; wherein the first surface of the planar EAS component comprises a perforation line defining a closed interior portion of the planar EAS component and an exterior portion of the planar EAS component; wherein the interior portion comprises the capacitor plate; wherein the perforation line has a depth extending from the first surface of the planar EAS component to the single adhesive layer of the planar EAS component and wherein the single adhesive layer has a strength such that, when the single adhesive layer is adhered to the object and the exterior portion is peeled away from the object, the planar EAS component tears along the perforation line and the interior portion remains adhered to the object.

### BRIEF DESCRIPTION OF THE DRAWINGS

The invention of the present disclosure will become more fully understood from the detailed description and the accompanying drawings, wherein:

FIG. 1 is a top view of a security label according to one embodiment.

FIG. 2 is an exploded perspective view of the security label of FIG. 1.

FIG. 3 is a cross-sectional view of the security label of FIG. 1 taken along line III.

FIG. 4 is a side view of the security label of FIG. 1 attached to an object.

FIG. 5 is a side view of the security label of FIG. 1 removed from the object.

FIG. 6 is a top view of a security label having a capacitor plate according to another embodiment.

FIG. 7 is a top view of a security label having a perforation line according to another embodiment.

FIG. 8 is a top view of a security label having RFID components according to another embodiment.

FIG. 9 is a flow chart of a method of manufacturing a security label according to one embodiment.

### DETAILED DESCRIPTION

The following description of the preferred embodiment(s) is merely exemplary in nature and is in no way intended to limit the invention or inventions. The description of illustrative embodiments is intended to be read in connection with the accompanying drawings, which are to be considered part of the entire written description. In the description of the exemplary embodiments disclosed herein, any reference to direction or orientation is merely intended for convenience of description and is not intended in any way to limit the scope of the present invention. Relative terms such as “lower,” “upper,” “horizontal,” “vertical,” “above,” “below,” “up,” “down,” “left,” “right,” “top,” “bottom,” “front” and “rear” as well as derivatives thereof (e.g., “horizontally,” “downwardly,” “upwardly,” etc.) should be construed to refer to the orientation as then described or as shown in the drawing under discussion. These relative terms are for convenience of description only and do not require that the apparatus be constructed or operated in a particular orientation unless explicitly indicated as such. Terms such as “attached,” “affixed,” “connected,” “coupled,” “interconnected,” “secured” and other similar terms refer to a relationship wherein structures are secured or attached to one another either directly or indirectly through intervening structures, as well as both movable or rigid attachments or relationships, unless expressly described otherwise. The discussion herein describes and illustrates some possible non-limiting combinations of features that may exist alone or in other combinations of features. Furthermore, as used herein, the term “or” is to be interpreted as a logical operator that results in true whenever one or more of its operands are true.

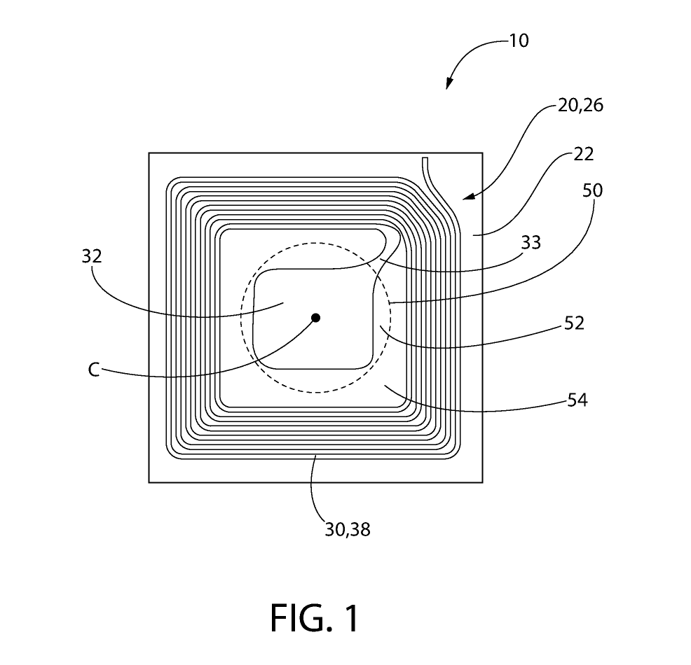

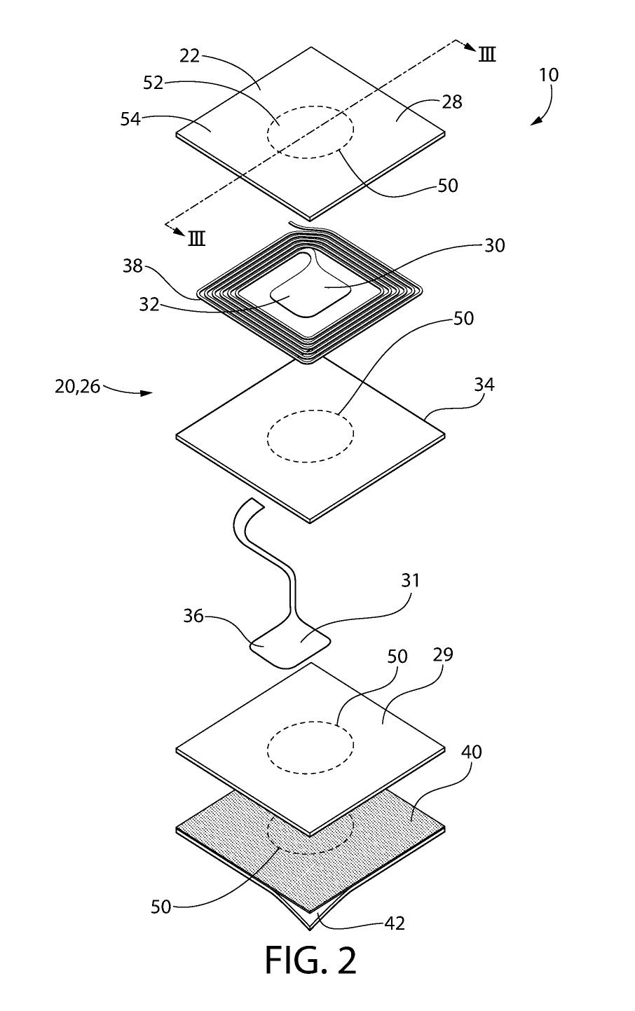

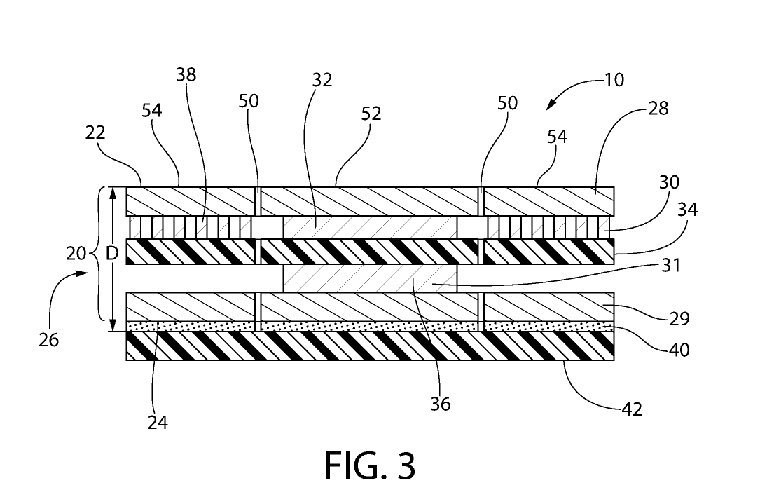

Referring now to the drawings, FIG. 1 is a top view of a security label 10 according to one embodiment. The exemplified label 10 includes a planar EAS component 20. The planar EAS component 20 can include a first surface 22 and an opposing second surface (see FIG. 3). In the exemplified embodiment, the planar EAS component 20 comprises a radio frequency (RF) resonant circuit 26. The resonant circuit 26 includes a first conductor 30 comprising a coil 38 and a first capacitor plate 32. The resonant circuit 26 further includes a second capacitor plate (see FIGS. 2-3). In other embodiments, the planar EAS component 20 can be any substantially planar component providing electronic article surveillance technology, including acousto-magnetic, and/or RFID (active or passive) technology.

The first surface 22 of the planar EAS component 20 can include a perforation line 50 defining a closed interior portion 52 of the planar EAS component 20 (the portion inside the closed perforation line 50) and an exterior portion 54 of the planar EAS component 20 (the portion outside the closed perforation line 50). The exemplified interior portion 52 has a circular shape that includes a portion of the conductor (namely, the first capacitor plate 32) and a center point C of the first surface 22 of the planar EAS component 20. Other embodiments can use other shapes (e.g., oval square, rectangle, triangle) and sizes, and can locate the interior portion anywhere on the first surface 22, including in a location such that the interior portion does not include the center point and/or does not include a conductor.

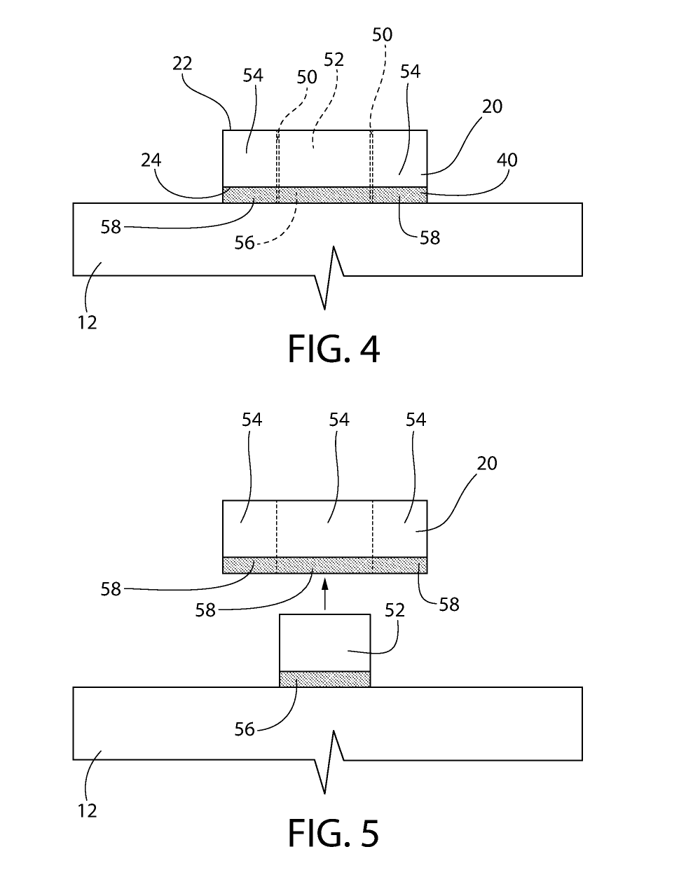

As will be described in more detail below, the label 10 can further comprise an adhesive layer adhered to the second surface of the planar EAS component 20 and configured to adhere the planar EAS component 20 to an object (see FIG. 4). This adhesive layer (sometimes referred to as an application adhesive later) can have a strength such that, when the application adhesive layer is adhered to the object and the exterior portion 54 is peeled away from the object, the planar EAS component 20 tears along the perforation line 50 and the interior portion 52 remains adhered to the object. In the exemplified embodiment, the perforation line 50 cuts through a portion of the neck 33 of the first conductor 30 to assist in separating the interior portion 52 from the exterior portion 54 when the label 10 is peeled away. In other embodiments, the cuts of the perforation line 50 can avoid the neck 33 to avoid potential interference with the circuit of which the first conductor 30 is a part.

Referring now to FIGS. 2 and 3, FIG. 2 shows an exploded perspective view of the security label 10 of FIG. 1, and FIG. 3 shows a cross-sectional view of the security label 10 taken along line Ill The exemplified label 10 includes a resonant circuit 26 haying a dielectric layer 34 located between a first capacitor plate 32 and a second capacitor plate 36. In the exemplified embodiment, the dielectric layer 34 is made from a polymeric material, preferably polypropylene. However, it will be recognized by those skilled in the art that the dielectric layer 34 may be made from a variety of non-conductive materials, including polyvinyl chloride, polystyrene, polyethylene, and other engineering thermoplastics which will be evident to those skilled in the art.

A first conductor 30 is positioned on a top side of the dielectric layer 34, and a second conductor 31 is positioned on a bottom side of the dielectric layer 34. The first conductor 30 includes a first capacitor plate 32, and the second conductor 31 includes a second capacitor plate 36. At least one of the conductors (in this embodiment, the first conductor 30) includes a coil 38 that can function as an inductor. The coil 38 has a spiral path surrounding the first capacitor plate 32, although an inductor 24 may be formed by other configurations. The first and second conductors 30, 31 can together form an inductive-capacitance resonant circuit 26. Such a circuit is capable of resonating when exposed to a certain electromagnetic field. For example, an EAS gate at an exit can provide an electromagnetic field that causes the label 10 to resonate, and the EAS gate can detect the resonating tag and alarm to indicate a potential theft.

The RF capacitor formed by the first capacitor plate 32 and the second capacitor plate 36 can be operably coupled to the coil 38. The first capacitor plate 32 and the coil 38 can be formed from the first conductor 30, and therefore these two components may be formed (e.g., via deposition and etching) already electrically coupled. To operably connect the RF capacitor to the coil 38, an electrical connection can be made between the second capacitor plate 36 of the RF capacitor, which was formed out of the second conductor 30, and the coil 38. The electrical connection may be made using commonly used crimping or welding processes.

In the present embodiment, it is preferred that each of the conductors 30, 31 be substantially planar and flexible. The conductors 30, 31 are preferably made from aluminum, specifically aluminum foil. However, one of ordinary skill in the art would understand that other conductive materials, such as copper or nickel, may be used for the conductors 30, 31. Further, one of ordinary skill in the art would understand that the conductors 30, 31 may be made from different conductive materials.

The conductors can be formed on the top and bottom sides of the dielectric layer 34, for example, by a dry lamination process or an extrusion coating process (not shown). One of ordinary skill in the art would understand that the process of forming the basic label structure comprising the conductors on the dielectric layer 34 is not specifically pertinent to an understanding of the disclosure and is well known in the prior art. Further description of this part of the fabrication process is not believed to be necessary nor is it limiting.

The exemplified label 10 includes a first polymeric film 28 adhered to and covering the first conductor 30 and the top side of the dielectric layer 34, and a second polymeric film 29 covering the second conductor 31 and the bottom side of the dielectric layer 34. The polymeric films 28, 29 can be both flexible and substantially planar to facilitate fabrication of the label 10 and adherence of the label 10 to non-planar surfaces on a wide variety of products and other objects to be protected by an electronic article surveillance system. The polymeric films 28, 29 can have a low moisture absorption, which can be advantageous in that a smooth, wrinkle-free printing surface and substantially consistent heat transfer properties are maintained, allowing easier fabrication of labels. The polymeric films 28, 29 can be made from any polymeric material, including polyester (e.g., Mylar or Melinex), polyethylene, polyvinyl chloride, and other plastics. The polymeric films 28, 29, however, are not required, and in some embodiments it is preferred that the first and second polymeric films 28, 29 be omitted.

The label 10 can further include adhesive layers. Such adhesive layers can include an application adhesive layer 40 adhered to the second surface 24 of the planar EAS component 20 and configured to adhere the planar EAS component 20 to an object (see FIG. 4). In the exemplified embodiment, this application adhesive layer 40 is adhered to a bottom side of the second polymeric film 29 and a release liner 42. Further, the exemplified application adhesive layer 40 has only a single layer of adhesive to enhance the strength of the adhesion to an object and to make the label 10 more difficult to peel off. In other embodiments, multiple adhesive layers stacked upon each other can be used for the application adhesive layer 40.

The label 10 Can further include additional adhesive layers (not shown), including adhesive layers that adhere each polymeric film to each respective conductor and side of the dielectric layer 34. In one embodiment, the adhesive layers each have a thickness of 0.5 to 2.0 mils.

The release liner 42 can comprise a paper or plastic film that is releasably adhered to the planar EAS component 20 (in the exemplified embodiment, the bottom side of the second polymeric film 29). The release liner 42 can be removed from the label 10 prior to attachment of the label 10 to the object to be protected. In some embodiments, the release liner 42 can have properties similar to the properties of the polymeric films 28, 29 discussed above. In other embodiments, the release liner 42 can be omitted and the planar EAS component 20 can be adhered directly to an object.

The cross-sectional view of FIG. 3 shows the depth D of the perforation line 50. In this embodiment, the perforation line 50 extends from the first surface 22 of the planar EAS component 20 to the second surface 24 of the planar EAS component 20, and through the adhesive layer 40, but not through the release liner 42. Thus, the exemplified perforation line 50 extends through the layers of the planar EAS component 20, including the dielectric layer 34 and any polymeric films 28, 29. In other embodiments, the perforation line 50 can have different depths (e.g., not extending through the application adhesive layer 40, or extending through the application adhesive layer 40 and at least a portion of the release liner 42), which can depend at least in part on the adhesive strength of the application adhesive layer 40.

It is noted that the exemplified planar EAS component 20 utilizes RF EAS technology. In other embodiments, however, the planar EAS component 20 can utilize other EAS technologies, including acousto-magnetic, magnetic, and/or RFID (active or passive) technology.

FIG. 4 shows a side view of the security label 10 of FIG. 1 attached to an object 12. In this figure, the components of the planar EAS component 20 are omitted for clarity. In the exemplified embodiment, the object 12 is a product or product packaging to be protected from theft. In other embodiments, the object 12 can be any object for receiving the security label 10.

The planar EAS component 20 is attached to the object 12 by the application adhesive layer 40. The planar EAS component 20 has a first surface 22 and a second surface 24. The application adhesive layer 40 is adhered to the second surface 24 of the planar EAS component 20 and is configured to adhere the planar EAS component 20 to the object 12. The perforation line 50 extends from the first surface 22 of the planar EAS component 20 to the bottom of the adhesive layer 40. The perforation line 50 divides the interior portion $2 of the planar EAS component 20 from the exterior portion 54 of the planar EAS component 20. The interior portion 52 is adhered to the object 12 by the adhesive interior portion 56, and the exterior portion 54 is adhered to the object 12 by the adhesive exterior portion 58.

FIG. 5 is a side view of the security label 10 of FIG. 1 removed from the object 12. The application adhesive layer 40 can have a strength such that, when the application adhesive layer 40 is adhered to the object 12 and the exterior portion 54 is peeled away from the object 12, the planar EAS component 20 tears along the perforation line 50 and the interior portion 52 remains adhered to the object 12. FIG. 5 shows the interior portion 52 remaining adhered to the object 12 by the adhesive interior portion 56. The exterior portion 54, however, has been peeled away, along with the adhesive exterior portion 58.

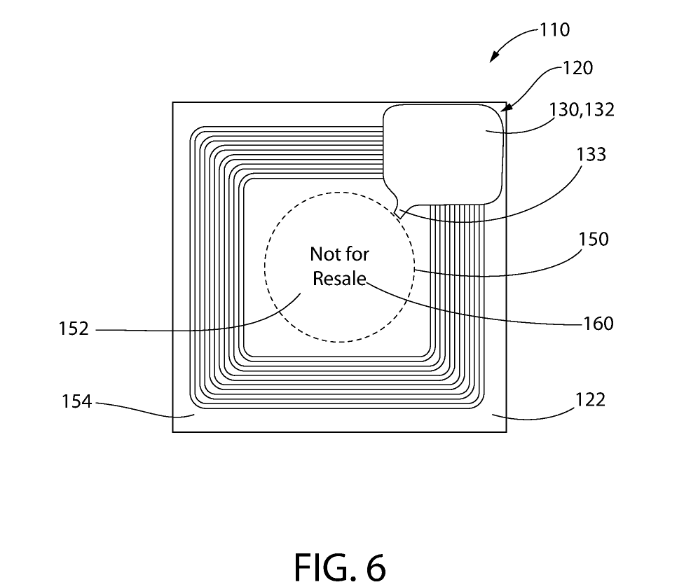

FIG. 6 is a top view of a security label 110 having a first capacitor plate 132 according to another embodiment. In this embodiment, the first capacitor plate 132 is folded over a neck 133 of the first conductor 130 such that the first capacitor plate 132 is not in the center of the label 110. Thus, even though the perforation line 150 encompasses the center of the first surface 122 of the planar EAS component 120, the perforation tine 150 does not encompass the first conductor 130. As stated above, in other embodiments, other configurations of an RF EAS component (or another EAS technology) can be utilized, and the perforation line can be placed in other locations.

In certain embodiments, a perforation line 150 is made in two steps. First, the label 120 can be die cut around the first capacitor plate 132 before the capacitor plate 132 is folded. Once the capacitor plate 132 is folded, a polymeric film (similar to first polymeric film 28) can be applied, and a second die cut through all layers of the planar'EAS component 120 can be made.

This figure also shows the interior portion 152 including indicia 160 indicating an unauthorized removal of the exterior portion 154. In the exemplified embodiment, the indicia 160 states “Not for Resale.” Thus, when a thief removes the exterior portion 154, the interior portion 152 will remain on the object to which it was adhered, and will still state “Not for Resale,” thereby hindering a thief's ability to resell the object. Other indicia could include other language, a store logo, an image giving the appearance of continued EAS protection, or other indicia.

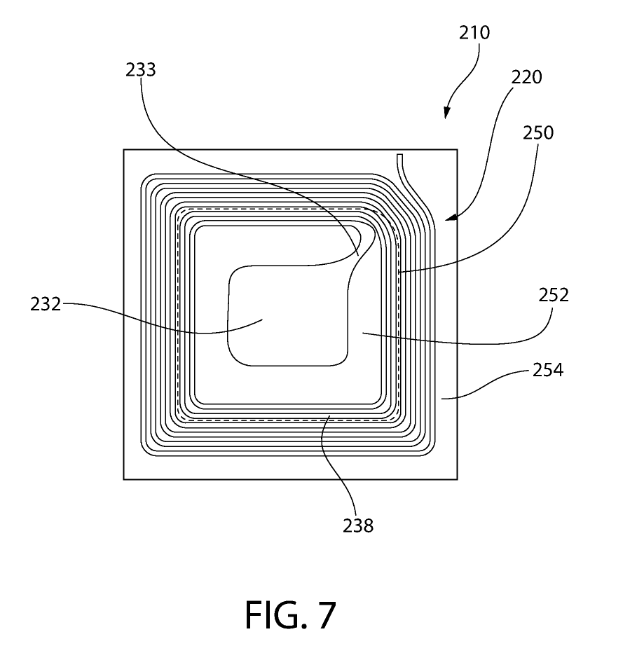

FIG. 7 is a top view of a security label 210 having a perforation line 250 according to another embodiment. This label 210 can be configured similar to the label of FIG. 1, but places the perforation line 250 in an alternative location on the planar EAS component 220. Specifically, the perforation line 250 is located such that the interior portion 252 formed by the perforation line 250 comprises a portion of the coil 238 (in addition to the capacitor plate 232). In this location, the perforation line 250 does not cut through the neck 233 of the first conductor 230, but can cut through a portion of the coil 238. In other embodiments, the cuts of the perforation line 250 can avoid the coil 238. In yet other embodiments, the perforation line can be placed at other locations on the planar EAS component 220.

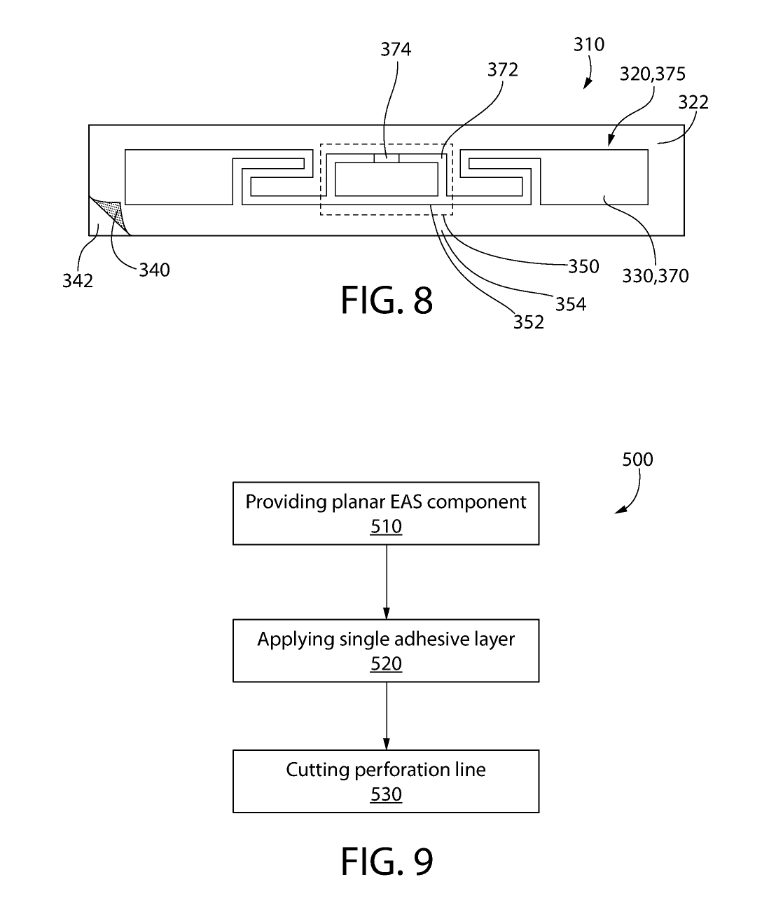

FIG. 8 is a top view off security label 310 liming RFID components according to another embodiment. In this embodiment, the planar EAS component 320 comprises an RIGID inlay 375, the RFID inlay 375 comprising a conductor 330 and an integrated circuit (IC) 374. The conductor 330 comprises a far field antenna 370 and a near field antenna 372, the IC 374 being connected to the near field antenna 372. The exemplified RFID inlay 375 is configured to perform modulated backscatter as part of a standard passive RFID system. As discussed above, in other embodiments, other EAS technologies (including other RFID technologies) can be used.

Similar to security label 10 of FIG. 1, the planar EAS component 320 has a first surface 322 and an opposing second surface (not shown). Further, the security label 310 includes an application adhesive layer 340 adhered to the second surface of the planar EAS component 320 and configured to adhere the planar EAS component 320 to an object. As shown, the application adhesive layer 340 can be releasably adhered to a release liner 342.

Also similar to earlier embodiments, the first surface 322 of the planar EAS component 320 of the exemplified label 310 comprises a perforation line 350 defining a closed interior portion 352 of the planar EAS component 320 and an exterior portion 354 of the planar EAS component 352. The application adhesive layer 340 can have a strength such that, when the application adhesive layer 340 is adhered to an object and the exterior portion 354 is peeled away from the object, the planar EAS component 320 tears along the perforation line 350 and the interior portion 352 remains adhered to the object. In this embodiment, the interior portion 352 comprises a portion of the RFID inlay 375, namely, the IC 374 and the near field antenna 372. In other embodiments, the interior portion 352 can comprise other portions of the planar EAS component 320.

FIG. 9 is a flow chart of a method 500 of manufacturing a security label according to one embodiment. The exemplified method 500 can include providing a planar EAS component having opposing first and second surfaces (operation 510). Further, the method 500 can include applying an application adhesive layer to the second surface, the adhesive layer configured to adhere the planar EAS component to an object (operation 520). Further, the method 500 can include cutting a perforation line in the planar EAS component, the perforation line defining a closed interior portion of the planar EAS component and an exterior portion of the planar EAS component (operation 530). In the exemplified embodiment, the perforation line is die cut, though in other embodiments other cutting methods can be used. The application adhesive layer can have a strength such that, when the application adhesive layer is adhered to the object and the exterior portion is peeled away from the object, the planar EAS component tears along the perforation line and the interior portion remains adhered to the object. In other embodiments, of other operations can be used.

The exemplified labels can provide several advantages. The remaining interior portion acts as a further deterrent to theft. For example, the remaining portion can include portions of the EAS component or an image (such as a lock image or an image of an EAS label) creating the illusion that the label is still providing EAS protection. Further, the remaining portion can include language (e.g., “Not for Resale”) that make resale difficult. Further, the exemplified labels can provide all these advantages at little to no additional cost. This is because the exemplified labels do not require additional materials, but instead simply require that the perforation line is cut, which can be done inexpensively during manufacture.

The use of a single adhesive layer for application to the object can provide strong adhesion that makes removal difficult. This assists the in enabling the planar EAS component to be torn when a thief attempts to peel off the label. The tearing along the perforation line, along with the strong adhesion provided by the application adhesive layer, ensures that the interior portion of the planar EAS component is left behind.

While the various example embodiments have been described with respect to specific examples, those skilled in the art will appreciate that there are numerous variations and permutations of the above that may be implemented without departing from the scope of the present invention. Also, it is to be understood that other embodiments may be utilized and structural and function& modifications may be made without departing from the scope of the present invention. Thus, the spirit and scope should be construed broadly as set forth in the appended claims.

What is claimed is:

1. A security label comprising:
a planar EAS component having opposing first and second surfaces; and
an adhesive layer adhered to the second surface of the planar EAS component and configured to adhere the planar EAS component to an object;
wherein the first surface of the planar EAS component comprises a perforation line defining a closed interior portion of the planar EAS component and an exterior portion of the planar EAS component; and
wherein the adhesive layer has a strength such that, when the adhesive layer is adhered to the object and the exterior portion is peeled away from the object, the planar EAS component tears along the perforation line and the interior portion remains adhered to the object.

2. The security label of claim 1 wherein the planar EAS component comprises a conductor and the interior portion comprises a portion of the conductor.

3. The security label of claim 2 wherein the conductor comprises a capacitor plate and the interior portion comprises the capacitor plate.

4. The security label of claim 2 wherein the conductor comprises a coil and the interior portion comprises a portion of the coil.

5. The security label of claim 1 wherein the planar EAS component comprises an REID inlay and the interior portion comprises a portion of the RFID.

6. The security label of claim 5 wherein the RFID inlay comprises an integrated circuit (IC) and the interior portion comprises the integrated circuit.

7. The security label of claim 1 wherein the interior portion includes a center point of the first surface of the planar EAS component.

8. The security label of claim 1 wherein the perforation line has a depth extending through the planar EAS component.

9. The security label of claim 1 wherein:
the adhesive layer is further adhered to a release liner; and
the perforation line has a depth extending from the first surface of the planar EAS component to the adhesive layer.

10. The security label of claim 1 wherein the planar EAS component comprises a resonant circuit.

11. The security label of claim 10 wherein:
the resonant circuit comprises a dielectric layer located between a first capacitor plate and a second capacitor plate; and
the perforation line has a depth extending through the dielectric layer.

12. The security label of claim 1 wherein the remaining interior portion comprises indicia indicating an unauthorized removal of the exterior portion.

13. The security label of claim 1 wherein the adhesive layer is a single adhesive layer.

14. A method of manufacturing a security label, the method comprising:
providing a planar EAS component having opposing first and second surfaces;
applying an adhesive layer to the second surface, the adhesive layer configured to adhere the planar EAS component to an object; and
cutting a perforation line in the planar EAS component, the perforation line defining a closed interior portion of the planar EAS component and an exterior portion of the planar EAS component;
wherein the adhesive layer has a strength such that, when the adhesive layer is adhered to the object and the exterior portion is peeled away from the object, the planar EAS component tears along the perforation line and the interior portion remains adhered to the object.

15. The method of claim 14 wherein the perforation line is die cut.

16. The method of claim 14 wherein the planar EAS component comprises a conductor and the interior portion comprises a portion of the conductor.

17. The method of claim 16 wherein the conductor comprises a capacitor plate and the interior portion comprises the capacitor plate.

18. The method of claim 16 wherein the conductor comprises a coil and the interior portion comprises a portion of the coil.

19. The method of claim 14 wherein the planar EAS component comprises an RFID inlay and the interior portion comprises a portion of the RFID inlay.

20. A security label comprising:
a planar EAS component having opposing first and second surfaces and a capacitor plate; and
a single adhesive layer adhered to the second surface of the planar EAS component and configured to adhere the planar EAS component to an object;
wherein the first surface of the planar EAS component comprises a perforation line defining a closed interior portion of the planar EAS component and an exterior portion of the planar EAS component;
wherein the interior portion comprises the capacitor plate;
wherein the perforation line has a depth extending from the first surface of the planar EAS component to the single adhesive layer of the planar EAS component; and
wherein the single adhesive layer has a strength such that, when the single adhesive layer is adhered to the object and the exterior portion is peeled away from the object, the planar EAS component tears along the perforation line and the interior portion remains adhered to the object.
